(19) United States
(12) Patent Application Publication
(10) Pub. No.: US 2008/0301020 A1
(43) Pub. Date: Dec. 4, 2008

(54) METHOD AND SYSTEM FOR BUSINESS CARD FUNCTIONING AS A PREPAID DEBIT CARD OR GIFT CARD

(75) Inventor: Ranjith R. Varakantam, Gainesville, VA (US)

Correspondence Address: PERKINS COIE LLP, P.O. BOX 1208, SEATTLE, WA, 98111-1208, US

(73) Assignee: WetCard, Gainesville, VA (US)

(21) Appl. No.: 11/839,356

(22) Filed: Aug. 15, 2007

Related U.S. Application Data
(60) Provisional application No. 60/941,265, filed on May 31, 2007.
(60) Provisional application No. 60/953,124, filed on Jul. 31, 2007.

(51) Int. Cl. G06Q 40/00

(52) U.S. Cl. 705/35

(57) ABSTRACT

A novel approach enables a customized smart business card that combines key features of a business card and a debit/gift card. The card not only carries information about a provider (a person and/or a business corporation who provides the card as a gift to the receiver), the card also functions as a prepaid/gift card, enabling the recipient of the card to purchase a product or service using the money/credit provided.

### RELATED APPLICATIONS

This application claims priority to U.S. Provisional Patent Application No. 60,941,265, filed May 31, 2007, and entitled “Business Card That Functions As A Prepaid Or Gift Card,” by Ranjith R. Varakantam, and U.S. Provisional Patent Application No. 60/953,124, filed Jul. 31, 2007, and entitled “Method And System For Business Card Functioning As A Prepaid Debit Card Or Gift Card,” by Ranjith R. Varakantam, both of which are hereby incorporated herein by reference.

### BACKGROUND

1. Field of invention

This invention relates to the field of debit cards and electronic transaction methods.

2. Background of the invention

Business card is the most commonly used means by business people to introduce themselves and exchange contact information with others. Due to proliferated use of the business cards, a business person may be legitimately concerned as whether the business card he/she sent out can stand out among hundreds even thousands of similar business cards received and get the attention of the recipient instead of being discarded. In addition, establishing business relations often calls for more than just the exchange of contact information. For non-limiting examples, a company may want to offer gift and/or free credit to the company's long time partners as a way of appreciation of their businesses over the years, or to potential clients to try out the company's latest products or services.

Electronic debit cards and gift cards issued by merchants/vendors/retailers are becoming increasingly popular in recent years, as such cards provide an easy and convenient way of gifting, allowing a recipient to purchase the gift he/she truly desires without the hassle of return or exchange. Since gift cards are currently massive produced and sold as a commoditized retail goods, gift cards carry the marking of their issuers or retailers only, without any indication of one of the most important aspect of gifting—the party who offers the gift. In addition, such gift cards can only be used to buy goods or services from the particular merchant or retailer who issued the cards.

### SUMMARY OF INVENTION

A novel approach enables a customized smart business card that combines key features of a business card and a debit/gift card. The card not only carries information about a provider (a person and/or a business corporation who provides the card as a gift to the receiver), the card also functions as a prepaid/gift card, enabling the recipient of the card to purchase a product or service using the money/credit provided.

### BRIEF DESCRIPTION OF THE DRAWINGS

FIGS. 1(a)-(b) are illustrations of an exemplary smart business card in accordance with one embodiment of the present invention.

FIG. 2 is a flow chart illustrating exemplary process to enable a customized smart business card in accordance with one embodiment of the present invention.

FIG. 3 shows an exemplary customized keychain of a non-rectangular shape with imprinted information of a business corporation on the key chain.

FIG. 4 is an illustration of an exemplary model where a customized smart business card is used as a debit or prepaid/gift card in accordance with one embodiment of the present invention.

FIG. 5 is an illustration of an exemplary model where a customized smart business card is used as a discount or rebate card in accordance with one embodiment of the present invention.

### DETAILED DESCRIPTION OF EMBODIMENTS OF THE INVENTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A novel approach enables a customized smart business card that combines key features of a business card and a debit or gift card. The card not only carries information about a provider (a person and/or a business corporation who provides the card as a gift to the receiver), the card also functions as a prepaid debit/gift card, enabling the recipient of the card to purchase a product or service using the money/balance/credit provided. More specifically, a first panel of the smart business card may present customized information about the provider and a second panel of the card may present information of the card as well as the managing entity that manages the card.

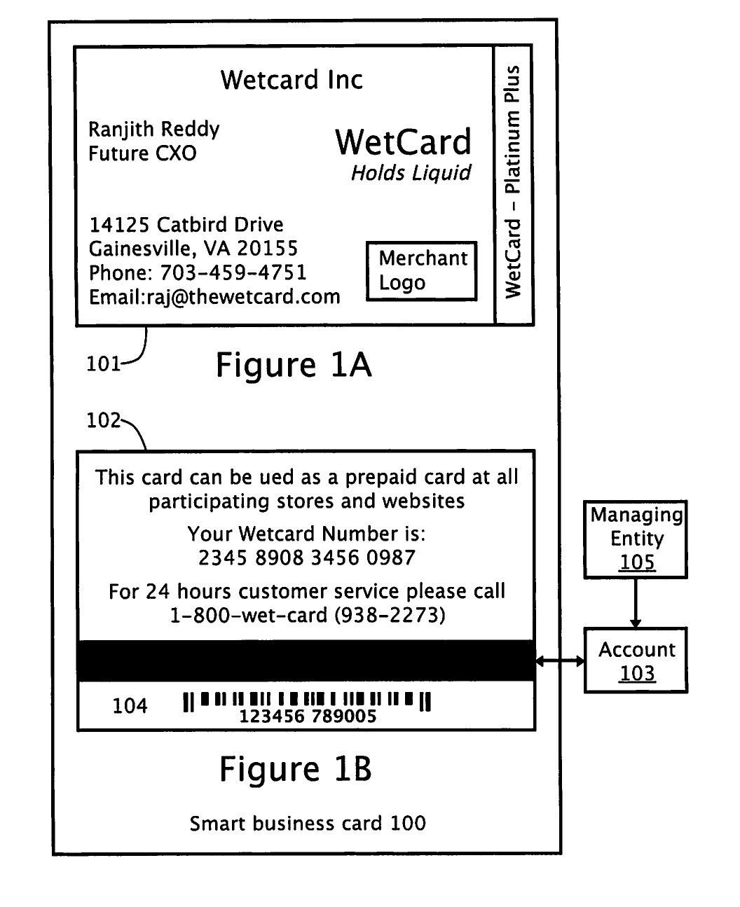

FIGS. 1(a)-(b) are illustrations of an exemplary smart business card 100 in accordance with one embodiment of the present invention. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

The smart business card 100 may comprise of two panels. Referring to FIG. 1(a), a first panel 101 of the card may present information related to the identification of a provider/creditor of the smart business card and/or the products or services provided by the provider. Information related to the provider includes but is not limited to, name, title and contact information of the person, company name, merchant logo, and location of the business corporation; information related to the product or service provided includes but is not limited to, trademark, description and/or ads of the product and/or service.

A (financial) account 103 can be associated with the card, which information includes but is not limited to, credit/gift amount initially charged to the account, transaction history of the account (i.e., transactions performed by the recipient of the card), and the remaining balance of the account. In addition, an electronic storing means 104 can be embedded in the smart business card, wherein such electronic storing means can be but is not limited to, a magnetic strip, an alpha numeric code or a barcode that stores information in an encoded form (wherein such information includes but is not limited to, membership number, raffle ticket number, or discount coupon codes), and/or an embedded smart chip that can store, record, and enable access to the information of the account.

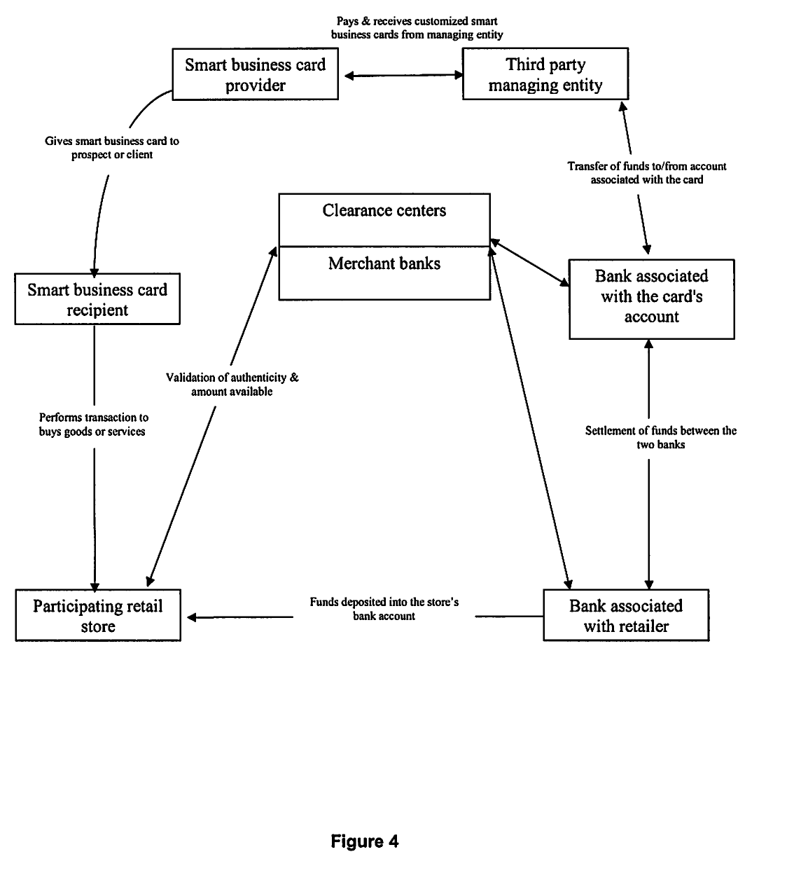

In some embodiments, the account associated with the smart business card can be issued by a third party managing entity 105 on behalf of the provider, wherein the managing entity is not associated with any specific merchant. In other words, the third party managing entity may function as the issuer of the smart business cards, and the provider may purchase the pre-charged smart business cards from the third party managing entity and give the cards to the recipient—prospect or client of the provider—as a prepaid/gift card. FIG. 4 is an illustration of an exemplary model where a customized smart business card is used as a debit or prepaid/gift card in accordance with one embodiment of the present invention.

In some embodiments, the third party managing entity can create the account associated with the card and enable the provider to access information of the account, charge, or alter credit amount in the account, allowing the provider to have a personalized smart business card issued in its own name and managed professionally with no professional expertise required for the provider. On the other hand, since the smart business card is managed by a third party independent (not tied to) of the provider or any specific merchant (unlike an ordinary gift card), the recipient of the card can use the card to purchase a product and/or service, which is not provided by the provider or any specific merchant, at any retail or online store.

In some embodiments, the managing entity is operable to transfer money/credit into the account 103 of the particular smart business card. The managing entity also enables the provider of the smart business card to perform one or more of: accessing transaction history of the recipient of the card, charging or altering the amount of credit in the account associated with the smart business card.

Referring to FIG. 1(b), a second panel 102 of the card may present card information, which includes but is not limited to, an identification number of the card, which could be a uniquely assigned 16 digit number that is predominantly used by most prepaid debit cards, gift cards and credit cards. In addition, the second panel may also present information of the managing entity, wherein such information includes but is not limited to, name and/or customer service number of the managing entity and its terms of use or service.

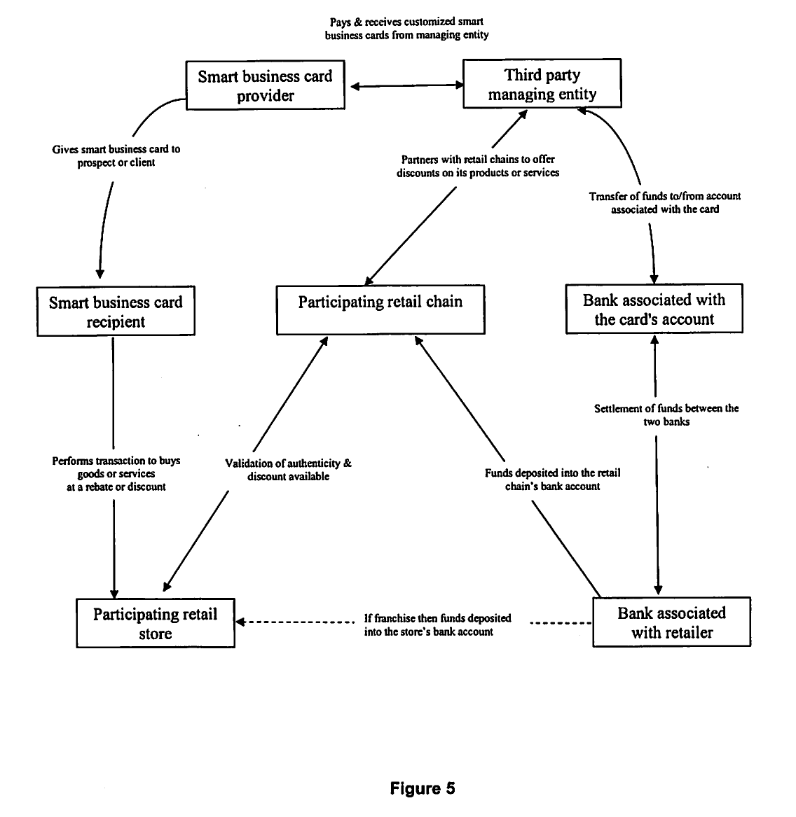

In some embodiments, the second panel may also contain information relating to coupon information, which can be printed in the form of barcode or alpha numeric code. At the time of purchase, the coupon can be scanned and appropriate amount of discount can be applied to the product or service purchased. FIG. 5 is an illustration of an exemplary model where a customized smart business card is used as a discount or rebate card in accordance with one embodiment of the present invention.

In some embodiments, the first and second panel can be on the front and back side of the card, and are thus referred to as front and back panel of the card, respectively.

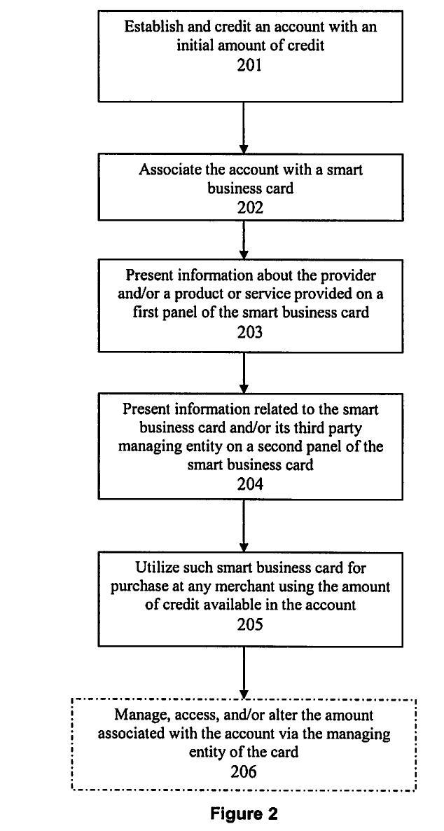

FIG. 2 is a flow chart illustrating exemplary process to enable a customized smart business card in accordance with one embodiment of the present invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 2, an account can be established and credited by a provider with an initial amount of credit at step 201, and the account can be associated with a smart business card at step 202. At step 203, information about the provider and/or a product or service provided can be presented on a first panel of the smart business card. At step 204, information related to the smart business card and/or its third party managing entity can be presented on a second panel of the smart business card. Such smart business card can then be utilized by a recipient for purchase at any merchant using the amount of credit or balance available in the account at step 205. The account can be managed, accessed and/or altered via the managing entity of the card at step 206.

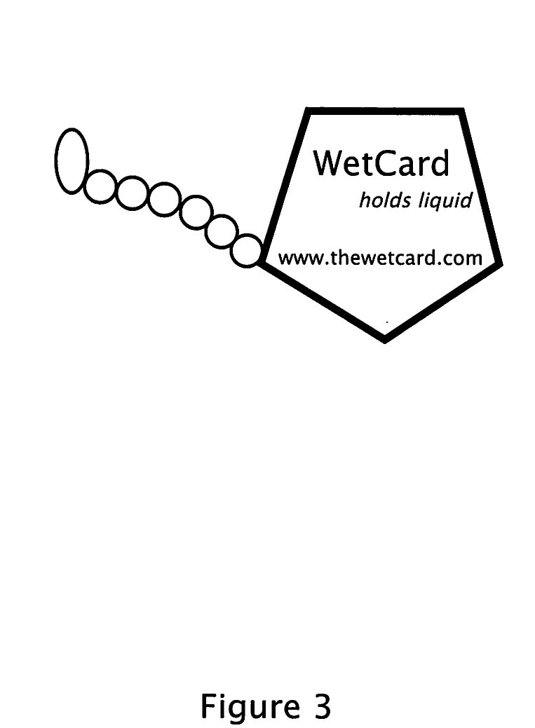

In some embodiments, the smart business card can be made available in many different shapes, sizes, and materials (for non-limiting examples, paper or plastic). Regardless of the form, the card may contain information relating to the identification of a business or person, and can be customized to carry additional information that would make the card function similar to a prepaid or gift card. For a non-limiting example, FIG. 3 shows an exemplary customized keychain of a non-rectangular shape with imprinted information of a business corporation on the key chain. The keychain can also be modified to contain a smart chip capable of storing the account information so that the keychain can be used to buy a product or service.

In some embodiments, the smart business card can include one or more of the following physical features on the first and/or second panel of the smart business card, in addition to what are described above:
A signature panel on the card.
A numeric security code feature (CVV2) to help in facilitating online transactions, which may appear either on the signature panel or to the side.
An expiration date of the card, similar to a debit card.
Names and/or logos of merchant services companies, for non-limiting examples, MasterCard, VISA, American Express, Discover, Diner Club Card etc. along with companies that facilitate electronic fund transfer (EFT), for non-limiting examples, Cirrus, Interlink, NYCE, Plus or Pulse.
An ultraviolet image element, which makes an image printed in ultraviolet ink visible when the card is placed under an ultraviolet light.
A 3D hologram, which moves when the card is tilted.

In some embodiments, the customized smart business card functions similar to a prepaid debit card, which is well-known to one skilled in the art, wherein the party who receives the card could use the card to purchase a product or service at any retail store or online website. Here, the product or service is not limited to that provided by the provider of the card or any specific merchant(s). When used at the retail store, the card can be swiped, scanned or tapped at checkout station to retrieve the account information and process payments. When used to make purchase at the online site/store, the recipient of the card may punch in the unique 16 digit identification number along with other information required to authenticate the card to purchase any product or service. These transactions can be similar to transactions via any other prepaid debit or gift cards as well known to one skilled in the art.

In some embodiments, the customized smart business card can be used similar to regular coupons for a financial discount or rebate when purchasing a product or service wherein the discount can be offered either as a percentage (e.g., 10%) or a dollar amount (e.g., $10). Here, the coupon can be offered as “coupon code,” “promotional code,” “promotion code,” “discount code” etc. Such coupon can be offered by the provider to allow the recipient, which can be business partner of the provider, to purchase the providers products or services at a discount. Alternatively, interested merchant may also have its coupon printed on the second panel of the smart business card to attract (but not limit) the recipient to purchase its products or services offered. When the smart business cards are swiped in the stores that honor these coupons, relevant information can be retrieved from the providers or merchant's database or third party database and corresponding discount can be applied to the product or service purchased.

In some embodiments, the customized smart business card can function as a raffle ticket or lottery ticket, wherein the company issuing the cards could hold a raffle or lottery for the cards issued. The receipt of the smart business card would be automatically enrolled and once the winning entries are randomly selected, the information would be published in various media and the card holder may contact the company to claim his/her prize.

In some embodiments, the smart business card holders could also receive additional benefits such as discounts or upgrades as they might be automatically enrolled into some membership clubs, which include but are not limited to, AAA, Automotive Rentals, Airlines etc.

In some embodiments, the smart business card itself could be classified into various categories such as gold, silver, platinum etc. based on the benefits and advantages that a particular business card provides and/or based on the monitory value of the business card.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “module” is used in the embodiments of the systems and methods described above, it will be evident that such concept can be interchangeably used with equivalent concepts such as, class, method, type, interface, bean, component, object model, and other suitable concepts. While the concept “means” is used in the embodiments of the systems and methods described above, it will be evident that such concept can be interchangeably used with equivalent concepts such as, class, method, type, interface, component, module, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to enable a customized smart business card, comprising:
an account associated with the said smart business card, wherein the account is operable to hold a specific amount of credit or balance offered by a provider of the smart business card;
a third party managing entity operable to perform one or more of:
issuing the smart business card on behalf of the provider;
establishing the account associated with the said smart business card; and
enabling the provider to:
access information of the account; and
charge or alter the amount of credit or balance in the account; and
said smart business card comprising of:
a first panel operable to present information related to identification of the provider; and
a second panel operable to present information related to the smart business card and/or the third party managing entity;
wherein said smart business card enables a recipient of the card to purchase a product or a service using the amount of credit or balance available in the account.

2. The system of claim 1, wherein:
the smart business card is in rectangular shape.

3. The system of claim 1, wherein:
the smart business card is in non-rectangular shape.

4. The system of claim 1, wherein:
the smart business card is made of paper or plastic.

5. The system of claim 1, wherein:
the smart business card functions as a prepaid debit card or gift card either at a retail store or at an online website.

6. The system of claim 1, wherein:
the information of the account includes one or more of: the amount of credit or gift initially charged to the account, transaction history of the account, and remaining credit balance of the account.

7. The system of claim 1, wherein:
the managing identity is independent of the provider or any specific merchant.

8. The system of claim 1, wherein:
the product and/or service purchased by the recipient is not provided by the provider or any specific merchant.

9. The system of claim 1, wherein:
the first and the second panel are on the front and the back side of the smart business card, respectively.

10. The system of claim 1, wherein:
the provider is a person or a business corporation.

11. The system of claim 10, wherein:
the information related to the provider includes one or more of: title and contact information of the person, name, logo, and location of the business corporation.

12. The system of claim 1, wherein:
the first panel of the smart business card is further operable to present information related to a product and/or a service provided by the provider.

13. The system of claim 12, wherein:
the information related to the product and/or service provided by the provider includes one or more of: trademark, description, and ads of the product and/or service provided.

14. The system of claim 1, wherein:
the information related to the smart business card includes one or more of: a unique identification number of the card, a barcode that stores information in an encoded form, a customer service number, and terms of use or service.

15. The system of claim 1, wherein:
the information related to the third party managing entity includes name and/or customer service number of the managing entity and its terms of use or service.

16. The system of claim 1, further comprising:
an electronic storing means embedded in the smart business card and operable to store, record, and enable access to the information of the account.

17. The system of claim 16, wherein:
the electronic storing means is a magnetic strip, a barcode that stores information in an encoded form, or a smart chip.

18. A method to enable a customized smart business card, comprising:
establishing an account to hold a specific amount of credit offered by a provider of said smart business card;
associating the account with said smart business card;
presenting information related to identification of the provider on a first panel of the smart business card;
presenting information related to the smart business card and/or its third party managing entity on a second panel of the smart business card; and
enabling a recipient of the card to purchase of a product and/or a service using the amount of credit available in the account.

19. The method of claim 18, further comprising:
issuing the smart business card on behalf of the provider.

20. The method of claim 18, further comprising:
enabling the provider to access information of the account and charge or alter the amount of credit in the account by the third party managing entity of the card.

21. The method of claim 18, further comprising:
presenting information related to a product and/or a service provided by the provider.

22. The method of claim 18, further comprising:
storing, recording, and enabling access to the information of the account via an electronic storing means embedded in the smart business card.

23. A machine readable medium having instructions stored thereon that when executed cause a system to:
establish an account to hold a specific amount of credit offered by a provider or account balance remaining in the account of said smart business card;
associate the account with said smart business card;
present information related to identification of the provider on a first panel of the smart business card;
present information related to the smart business card and/or its third party managing entity on a second panel of the smart business card; and
enable a recipient of the card to purchase of a product and/or a service using the amount of credit or balance available in the account.

24. A system to enable a customized smart business card, comprising:
means for establishing an account to hold a specific amount of credit offered by a provider of said smart business card;
means for associating the account with said smart business card;
means for presenting information related to identification of the provider on a first panel of the smart business card;
means for presenting information related to the smart business card and/or its third party managing entity on a second panel of the smart business card; and
means for enabling a recipient of the card to purchase of a product and/or a service using the amount of credit available in the account.
